(19) United States
(12) Patent Application Publication
(10) Pub. No.: US 2023/0221568 A1
(43) Pub. Date: Jul. 13, 2023

(54) CALIBRATION AND USE OF EYE TRACKING

(71) Applicant: Meta Platforms, Inc., Menlo Park, CA (US)

(72) Inventors: James Schultz, Redmond, WA (US); Tamer Elazhary, Redmond, WA (US); Robin Sharma, Woodinville, WA (US); Eredzhep Menumerov, San Jose, CA (US); Pavel Trochtchanovitch, Redmond, WA (US); Anthony Draper, Sammamish, WA (US); Wei Wu, Bellevue, WA (US); Andrew Barolet, Bellevue, WA (US); Hammad Ahsan, Kirkland, WA (US); Angela Paulina Pachacz, Kirkland, WA (US)

(21) Appl. No.: 18/154,389

(22) Filed: Jan. 13, 2023

Related U.S. Application Data
(60) Provisional application No. 63/299,169, filed on Jan. 13, 2022.
(60) Provisional application No. 63/351,240, filed on Jun. 10, 2022.
(60) Provisional application No. 63/387,387, filed on Dec. 14, 2022.

(51) Int. Cl. G02B 27/01; G02B 27/00

(52) U.S. Cl. CPC G02B 27/0179; G02B 27/0172; G02B 27/0081; G02B 2027/0178; G02B 2027/0138; G02B 2027/0174; G02B 2027/0187

(57) ABSTRACT

Systems, methods, and apparatuses for an eye tracking system to track eye movement via a camera and lens module utilizing a low-profile phase element, such as a holographic optical element (HOE), or a multipurpose sensor are provided. Systems and methods may include a multipurpose sensor to detect changes in light and determine occurrence of eye movement, a lens module (e.g., waveguide) configured to project an image covering a first field of view within an eye relief zone, to a camera positioned adjacent to the lens module and configured to track eye movements within a second field of view, and a low-profile phase element positioned in front of the camera. Light reflected from the user's eyes is transmitted via lens module to the camera which responds to eye reflection data of the second field of view. Systems and apparatuses for a calibration system to perform key performance indicator testing for eye tracking systems are provided. The system may include a camera positioned in front of an artificial eye or object being tested and an eye tracking system positioned. The camera may include calibrated ground truth data for eye tracking systems. They camera may be attached to a mount with kinematic mounting features. The mount may be positioned anterior of the eye tracking system and magnetized, enabling the interchangeability of the camera and mount between different eye tracking systems. The calibration system may include a lens arranged to guide light through the eye tracking system and to the artificial eye, where the reflection of light may be observed by the eye tracking system and the camera of the calibration system.

### CROSS-REFERENCE TO RELATED APPLICATIONS

This application claims the benefit of U.S. Provisional Patent Applications No. 63/299,169, filed Jan. 13, 2022, entitled “Eye Tracking Waveguide Closed Loop Reflection”, 63/351,240 filed Jun. 10, 2022, entitled “Camera Module With Low Profile Phase Element For Eye-Tracking Systems And Devices”, and 63/387,387, filed Dec. 14, 2022, entitled “Interchangeable Eye Tracking Calibration,” the entire content of which is incorporated herein by reference.

### TECHNOLOGICAL FIELD

Examples of this disclosure relate generally to methods, apparatuses, or computer program products for eye tracking and eye tracking calibration.

### BACKGROUND

Artificial reality is a form of immersive reality that has been adjusted in some manner before presentation to a user, which may include, for example, a virtual reality, an augmented reality, a mixed reality, a hybrid reality, Metaverse reality or some combination or derivative thereof. Artificial reality content may include completely computer-generated content or computer-generated content combined with captured (e.g., real-world) content. The artificial reality content may include video, audio, haptic feedback, or some combination thereof, any of which may be presented in a single channel or in multiple channels (such as stereo video that produces a three-dimensional (3D) effect to the viewer). Additionally, in some instances, artificial reality may be associated with applications, products, accessories, services, or some combination thereof, that may be used to, for example, create content in an artificial reality or are otherwise used in (e.g., to perform activities in) an artificial reality. Head-mounted displays (HMDs) including one or more near-eye displays may often be used to present visual content to a user for use in artificial reality applications.

Artificial reality displays, including HMDs, may utilize eye tracking to accurately present content and images to the user. Eye tracking may be used to enable gaze foveated rendering, improve world-locked rendering and many additional user experience features. In order for eye tracking to accomplish such features, the eye tracking system must be calibrated and tuned during development or manufacturing (e.g., before the artificial reality system reaches users). During development or manufacturing the generation of ground truth data may be important to the performance of eye tracking systems. Ground truth data may be data that represents reality to compare against what the eye tracking system determines (or captures). Although ground truth data may need to be obtained for performance purposes in artificial reality systems, the process to obtain ground truth data may slow production time. This process may be slow because the determination of each level of performance, i.e., gaze angle, pupil locations, of the eye tracking system may need to be calibrated by different calibration systems requiring recalibration of a calibration system for each assessment of performance.

In conventional eye tracking systems at least one camera will track where a user is looking or focusing, and the display system uses that information accordingly. However, a challenge with eye tracking, especially in HMDs, is the placement of the cameras so that they do not protrude into a user's eye relief zone and field of view (FOV). Camera protrusion in the eye relief zone effectively decreases the lens FOV and negatively affects user experience. Accordingly, there is a need for improved eye tracking elements and placement.

In view of the foregoing drawbacks, it may be beneficial to provide improved eye tracking elements and placement, as well as an improved system of determining key performance indicators (KPIs) of eye tracking systems for a multitude of eye tracking platform architectures.

### BRIEF SUMMARY

In meeting the foregoing drawbacks, the present disclosure provides systems and methods for eye-tracking using camera modules with a low-profile phase element or a single multipurpose sensor that detects changes in light. Examples of low-profile phase elements may include a holographic optical element (HOE), such as a Volume Bragg Grating (VBG), a Polarization Volume Hologram (PVH), or a diffractive optical element (DOE), including surface relief gratings (SRGs), binary kinoforms, or the like. Other implementations of low-profile phase elements may include a Pancharatnam-Berry Phase Elements (PBP), meta-surface phase element, or a prism, such as a Fresnel prism or first order Fresnel lens.

Examples may comprise one or more cameras or lens modules utilizing a low-profile phase element positioned adjacent to the lens module, and outside of an eye relief zone defined by a lens module. The lens module may be configured to project an image to a light observing element, such as an eye, and covering a first FOV. The camera, which may be positioned adjacent to the lens module, may be configured to track eye movements within a second FOV. The low-profile phase element is positioned in front of the camera and configured to diffract the second FOV of the camera to capture a greater area of the first FOV than without the low-profile phase element. Both the low-profile phase element and the camera may be positioned outside of the eye relief zone.

Alternatively, an eye tracking system may utilize a closed loop reflection of light for a HMD. Such systems may include a single multipurpose sensor that detects changes in light in combination or in lieu of camera modules with a low-profile phase element.

In an example, a system may include a lens module (i.e., waveguide) having a front and a rear surface, for a display system and arranged to project light onto a light observing element, such as an eye of a user to make an image visible to the user, the light guided through the lens module; and a multipurpose sensor that detects changes in light to track a user's eye. In alternative examples, a system may include a lens module having a front and rear surface, the lens module for a display system and arranged to guide light onto an eye of a user to make an image visible to the user (i.e., first FOV), a multipurpose sensor that detects changes in light; and one or more cameras and lens modules utilizing a low-profile phase element positioned adjacent to the lens module (i.e., waveguide), and outside of an eye relief zone defined by a lens module to track the light observing element (i.e., second FOV). The low-profile phase element may be positioned in front of the camera and configured to diffract the second FOV of the camera to capture a greater area of the first FOV than without the low-profile phase element. The low-profile phase element, the camera, and the multipurpose sensor may be positioned outside of the eye relief zone.

In various examples, the eye relief zone is based on a distance between a light observing element, such as an eye, and the lens. In other examples, the first FOV is an observable FOV for a light observing element positioned a distance from the lens. The lens module and the low-profile phase element may be positioned such that they do not protrude into the eye relief zone. In other examples, the lens module and the low-profile phase element may be flush along a same horizontal plane. In various examples, application of a low-profile phase element allows diffraction of the camera's FOV into a plurality of directions, and therefore provides customization and variety in design configurations. In various examples, the low-profile phase element and camera may be configured to cover a FOV including at least one of a light observing element (e.g., and eye), and facial features. The camera and low-profile phase element may be positioned at the lens surface level or below, such that there is no protrusion into the eye relief region.

In meeting the foregoing drawbacks, the present disclosure further provides systems and methods for a calibration system which may be associated with determining key performance indicators (KPIs) for eye tracking systems. The system may include one or more cameras positioned in front of an artificial eye used for testing and a set of calibrated ground truth data for eye tracking systems. The calibration system may capture KPIs such as gaze angle, 3D pupil locations, etc. The system may utilize calibrated ground truth data to determine KPIs associated with an artificial reality device and proceed to determine the KPIs from another eye tracking system without recalibration.

For instance, the calibration system may determine gaze angle, and pupil locations, based on calibrated ground truth data in accordance with eye tracking systems. The calibration system may provide a mechanism for using calibrated ground truth data, associated with eye tracking, at the same time utilizing camera sensors such as, for example, a stereo camera and by utilizing this information to determine performance of one or more parameters such as, for example, gaze angle, pupil locations, or any parameter that may be useful for eye tracking purposes. By combining these parameters that may be captured or determined based on an image capture of an eye or an artificial eye-like object(s) that may be for testing or using an HMD. Considering the parameters (e.g., together, or separately) may allow the calibration system to maintain performance testing goals of eye tracking systems while shortening manufacturing or testing time of eye tracking systems.

In an example, a system may include one or more cameras attached to a mount with kinematic mounting features. The mount may be magnetized to allow for interchangeability of the system between different eye tracking systems. The mount may be placed anterior of an eye tracking system and an artificial eye. The system may further comprise a light source to provide light to an artificial eye used for testing purposes. The system may include stereo cameras that may capture or determine gaze vector, 3D pupil locations, etc. associated with captured reflections of illuminated light and movement of the artificial eye in accordance with the eye tracking system as light is guided through the lens of the calibration system.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings examples of the disclosed subject matter; however, the disclosed subject matter is not limited to the specific methods, compositions, and devices disclosed. In addition, the drawings are not necessarily drawn to scale. In the drawings:

FIG. 1 illustrates an example HMD associated with artificial reality content.

FIG. 2 illustrates a block diagram of an exemplary hardware or software architecture in accordance with an example.

FIG. 3 illustrates a camera and lens configuration wherein the camera protrudes into an eye relief zone.

FIG. 4 illustrates an alternate view of the lens configuration of FIG. 1.

FIG. 5A illustrates the obstructed camera FOV in a configuration where the camera is positioned below a surface of the lens.

FIG. 5B illustrates the FOV for a configuration where the camera is positioned at least partially within the eye relief zone.

FIG. 6 illustrates a camera FOV for an example comprising a low-profile phase element in accordance with examples of the present disclosure.

FIG. 7A illustrates a ray tracing analysis for systems utilizing a low-profile phase element, in accordance with examples of the present disclosure.

FIG. 7B illustrates a spot diagram corresponding to the configuration provided in FIG. 5A, in accordance with examples of the present disclosure.

FIG. 8A illustrates a ray tracing analysis for systems that do not utilize a low-profile phase element, in accordance with examples of the present disclosure.

FIG. 8B illustrates a spot diagram corresponding to the configuration provided in FIG. 6A, in accordance with examples of the present disclosure.

FIG. 9 illustrates an exemplary zoomed plan view of the HMD that includes lens module and a multipurpose sensor taken at dashed circle A of FIG. 1 in accordance with an example.

FIG. 10 illustrates an exemplary zoomed side view of the HMD.

FIG. 11A illustrates camera positioning and an observable FOV on a head-mounted system without a low-profile phase element.

FIG. 11B illustrates camera positioning and an observable FOV on a head-mounted system with a low-profile phase element, in accordance with examples of the present disclosure.

FIG. 12A illustrates an example camera placement on another head-mounted system without a low-profile phase element.

FIG. 12B illustrates an example camera placement on a head-mounted system with a low-profile phase element, in accordance with examples of the present disclosure.

FIG. 13 illustrates an exemplary pathway of light reflected from an eye, in accordance with an example.

FIG. 14 illustrates a method associated with eye tracking utilizing a camera low-profile phase element and a multipurpose sensor, in accordance with an example.

FIG. 15 is a cross-sectional view of an example HMD of FIG.1 with artificial eyes used for testing in accordance with an exemplary embodiment.

FIG. 16 illustrates a ground truth system positioned anteriorly to an eye tracking system in accordance with an example.

The figures depict various examples for purposes of illustration only. One skilled in the art will readily recognize from the following discussion that alternative examples of the structures and methods illustrated herein may be employed without departing from the principles described herein.

### DETAILED DESCRIPTION

Some examples of the present invention will now be described more fully hereinafter with reference to the accompanying drawings, in which some, but not all examples of the invention are shown. Indeed, various examples of the invention may be embodied in many different forms and should not be construed as limited to the examples set forth herein. Like reference numerals refer to like elements throughout.

As defined herein a “computer-readable storage medium,” which refers to a non-transitory, physical, or tangible storage medium (e.g., volatile, or non-volatile memory device), may be differentiated from a “computer-readable transmission medium,” which refers to an electromagnetic signal.

As referred to herein, a light projector may be any light source that projects light used in augmented reality systems including, but not limiting to, a light point source or a laser scanning projector.

As referred to herein, diffraction may refer to an instance in which a beam of light or other system of waves is spread out as a result of passing through a narrow aperture or across an edge.

It is to be understood that the methods and systems described herein are not limited to specific methods, specific components, or to particular implementations. It is also to be understood that the terminology used herein is for the purpose of describing particular examples only and is not intended to be limiting.

HMD's including one or more near-eye displays may often be used to present visual content to a user for use in artificial reality applications. One type of near-eye display may include an enclosure that houses components (e.g., eye tracking system, etc.) of the near-eye display or is configured to rest on the face of a user, such as for example a frame. The near-eye display may include a lens module (e.g., waveguide) that may direct light from a light projector to a location in front of a user's eyes (e.g., eye 108). Because of human visual sensitivity, slight deviations in optical quality may be apparent to the user of a near-eye display, thus it may be important to calibrate HMDs eye tracking systems prior to user reception. Additionally, tracking of the eyes (e.g., eye 108) of a user may be beneficial for graphics rendering or user peripheral input.

A main challenge in eye tracking system designs is providing cameras and other hardware in a manner that does not interfere with user experience and comfort. In eye tracking systems, such as a virtual reality device, or other head-mounted display device, there exists a challenge in concealing cameras, such that they do not protrude into the eye relief zone and interfere with the user's field of vision or function of other hardware components.

The present disclosure is generally directed to systems and methods for to an eye tracking system based on user eye disparity information for artificial reality displays. Examples in the present disclosure may include head-mounted displays that may comprise one or more cameras and lens modules using a low-profile phase element positioned adjacent to the lens module, and a multipurpose sensor coupled with the enclosure. A waveguide (e.g., lens module) may be configured to direct images from a light projector to a user's eye.

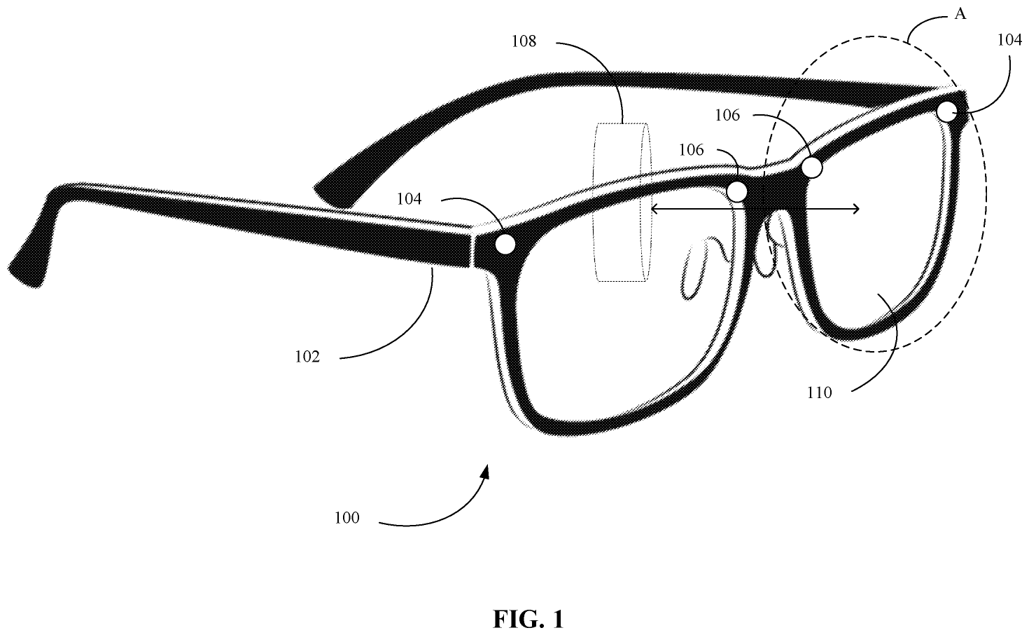

FIG. 1 illustrates an example HMD 100 associated with artificial reality content. HMD 100 may include enclosure 102 (e.g., an eyeglass frame), a camera 104, a multipurpose sensor 106, and a lens module 110. Waveguide (e.g., lens 110) may be configured to direct images to a user's eye. In some examples, HMD 100 may be implemented in the form of augmented-reality glasses. Accordingly, the waveguide 110 may be at least partially transparent to visible light to allow the user to view a real-world environment through the waveguide 110. FIG. 1 also shows a representation of an eye (e.g., eye 108) that may be a real eye or an artificial eye-like object that may be for testing HMD 100.

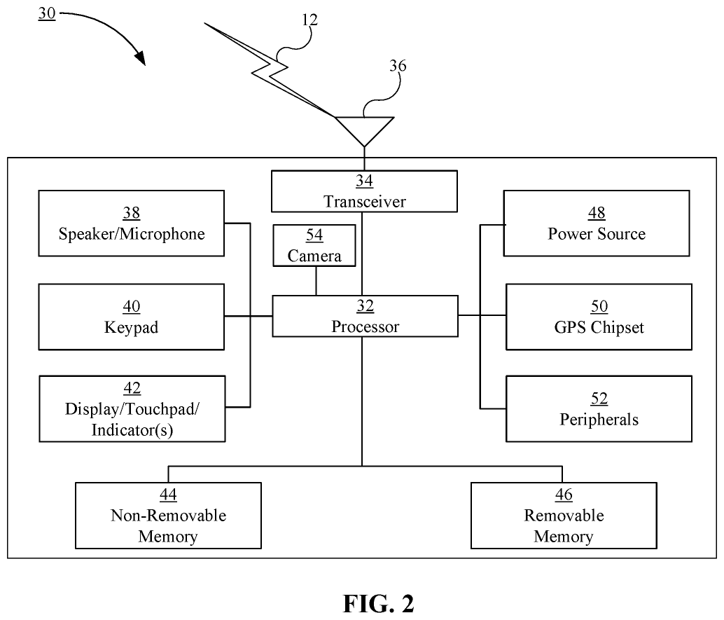

The HMD 100 may include an audio device (e.g., speaker/microphone 38 of FIG. 2) that may provide audio content to users. The HMD 100 may include one or more cameras 104, which may capture images and videos of environments. The HMD 100 may include an eye 108 tracking system to track the vergence movement of the user wearing the HMD 100. In one example, the camera 104 or the multipurpose sensor 106 may comprise the eye tracking system. The HMD 100 may include a microphone of the audio device to capture voice input from the user. The system may further include a controller (e.g., processor 32 of FIG. 2) comprising a trackpad and one or more buttons. The controller may receive inputs from users and relay the inputs to the computing device 112. The controller may also provide haptic feedback to users. The computing device 112 may be connected to the HMD 100 and the controller through cables or wireless connections. The computing device 112 may control the HMD 100 and the controller to provide content to and receive inputs from one or more users. In some examples, the controller may be a standalone controller or integrated within the HMD 100. The computing device 112 may be a standalone host computer device, an on-board computer device integrated with the HMD 100, a mobile device, or any other hardware platform capable of providing artificial reality content to and receiving inputs from users.

Tracking of eye 108 may be beneficial for graphics rendering or user peripheral input. Conventionally, it may be difficult to track eye 108 without being noticeable to the user, not consuming too much physical space or weight, and not increasing the overall system cost. In conventional HMDs 100 one or more cameras 104 (e.g., an eye tracking camera) and one or more multipurpose sensors 106 may be positioned to track eye 108. Camera 104 and multipurpose sensor 106 may respond to the reflection of light off the eyes (e.g., eye 108). Camera 104 and multipurpose sensor 106 may be located on frame 102 in different positions. The camera 104 and the multipurpose sensor 106 may be located along a width of a section of frame 102. In some other examples, the camera 104 or the multipurpose sensor 106 may be arranged on one side of frame 102 (e.g., a side of frame 102 nearest to the eye 108). Alternatively, in some examples, the camera 104 or multipurpose sensor 106 may be located on waveguide 108.

FIG. 2 illustrates a block diagram of an exemplary hardware or software architecture of a communication device such as, for example, user equipment (UE) 30. In some examples, the UE 30 may be a computer system such as for example HMD 100, smart glasses, an augmented or virtual reality device, a desktop computer, notebook or laptop computer, netbook, a tablet computer (e.g., a smart tablet), e-book reader, GPS device, a camera (e.g. camera 104), a multipurpose sensor (e.g., multipurpose sensor 106), personal digital assistant, handheld electronic device, cellular telephone, smartphone, smart watch, charging case, or any other suitable electronic device. As shown in FIG. 2, the UE 30 (also referred to herein as node 30) may include a processor 32, non-removable memory 44, removable memory 46, a speaker or microphone 38, a keypad 40, a display, touchpad, or indicators 42, a power source 48, a global positioning system (GPS) chipset 50, and other peripherals 52. The power source 48 may be capable of receiving electric power for supplying electric power to the UE 30. For example, the power source 48 may include an alternating current to direct current (AC-to-DC) converter allowing the power source 48 to be connected or plugged to an AC electrical receptable or Universal Serial Bus (USB) port for receiving electric power. The UE 30 may also include one or more cameras 54. In an example, the camera(s) 54 may be a smart camera configured to sense images or video appearing within one or more bounding boxes. The UE 30 may also include communication circuitry, such as a transceiver 34 and a transmit or receive element 36. It will be appreciated the UE 30 may include any sub-combination of the foregoing elements while remaining consistent with an example.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 or memory 46) of the node 30 in order to perform the various required functions of the node. For example, the processor 32 may perform signal coding, data processing, power control, input or output processing, or any other functionality that enables the node 30 to operate in a wireless or wired environment. The processor 32 may run application-layer programs (e.g., browsers) or radio access-layer (RAN) programs or other communications programs. The processor 32 may also perform security operations such as authentication, security key agreement, or cryptographic operations, such as at the access-layer or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, the transmit/receive element 36 may be an antenna configured to transmit or receive radio frequency (RF) signals. The transmit/receive element 36 may support various networks and air interfaces, such as wireless local area network (WLAN), wireless personal area network (WPAN), cellular, and the like. In yet another example, the transmit/receive element 36 may be configured to transmit or receive both RF and light signals. It will be appreciated that the transmit/receive element 36 may be configured to transmit or receive any combination of wireless or wired signals. The transmit/receive element 36 may also be configured to connect the UE 30 to an external communications network, such as network 12, to enable the UE 30 to communicate with other nodes (e.g., other UEs 30, network device 160, etc.) of the network.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other examples, the processor 32 may access information from, and store data in, memory that is not physically located on the node 30, such as on a server or a home computer.

The processor 32 may receive power from the power source 48, and may be configured to distribute or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an example.

### A. Camera Module With Low Profile Phase Element For Eye-Tracking Systems And Devices

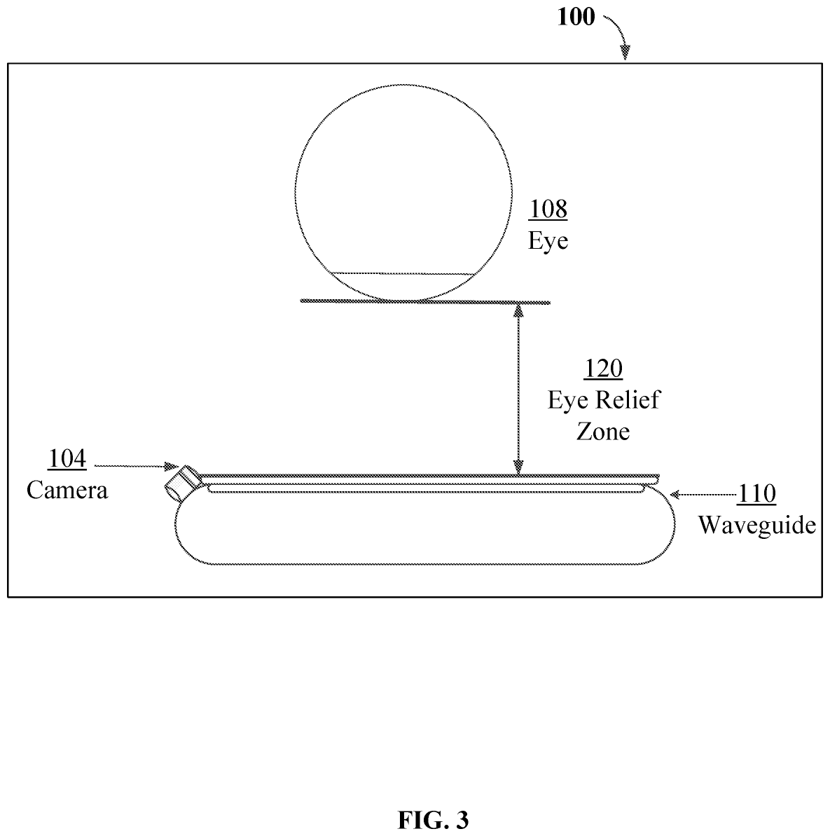

FIG. 3 illustrates an exemplary overhead view of a conventional HMD 100 that includes camera 104 and waveguide 110 in the dashed circle A of FIG.1, wherein the camera 104 protrudes into an eye relief zone. The distance between the waveguide 110 (e.g., lens module or lens) and eye 108 defines the eye relief zone 120. As illustrated in FIG. 3, the camera 104 is placed at an angle, and protrudes over the plane of the lens 110 (e.g., waveguide 110) into the eye relief zone 120. When a component protrudes into an eye relief zone, it effectively decreases the lens module's FOV. A decrease in the lens module's FOV may negatively affect user experience. A user may, for example, notice an object in the periphery, their FOV may become obstructed, and such objects may be distracting to the user's operation of the device.

In conventional systems and configurations, there is typically a part of the eye tracking camera that protrudes into the eye relief zone 120. This is because the camera position may need to be pointed toward the eye to fully observe the eye 108 and track eye movements. The camera is often mounted to observe the eyeball (e.g., eye 108) and, in some examples, facial features, within its FOV.

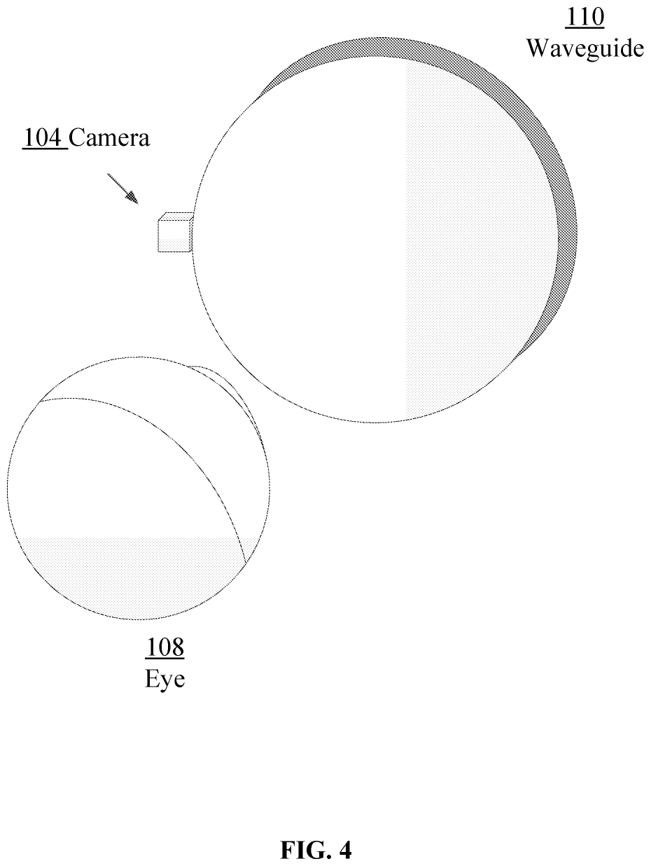

FIG. 4 illustrates another angle of the traditional camera positioning for eye tracking systems, discussed in FIG. 3. The camera 104 visibly protrudes over the plane of the lens 110, and into the eye relief zone 120. The observing eye 108 may be able to see camera 104 due to its positioning.

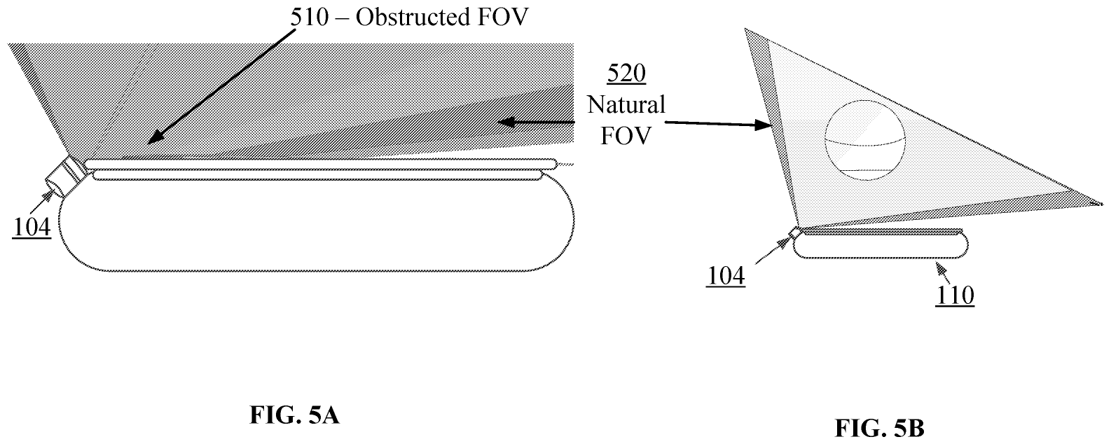

FIGS. 5A and 5B further illustrate the obstructed view observed from conventional systems, with an angled camera or protrusion above the plane of the lens (e.g., waveguide 110), into the eye relief zone (e.g., eye relief zone 120). FIG. 5A illustrates an example where the camera (e.g., camera 104) is lowered so that it does not protrude into the eye relief zone (e.g., eye relief zone 120). However, doing so may obstruct or clip the camera's FOV, and may result in the obstructed FOV 510. The natural FOV 520 is clipped or obstructed, as part of the camera's observations are blocked by the lens (e.g., waveguide 110).

FIG. 5B provides another view of the camera positioning of FIGS. 3-4, wherein the camera 104 protrudes into the eye relief zone (e.g., eye relief zone 520). Although this may result in a greater FOV than the obstructed FOV 510 illustrated in FIG. 5A, the illustrated configuration limits the lens's (e.g., waveguide 110) FOV, and therefore negatively affects user experience. In other words, the images provided by lens module 110 may be partially blocked by the part of the camera 104 protruding into the eye relief zone 120.

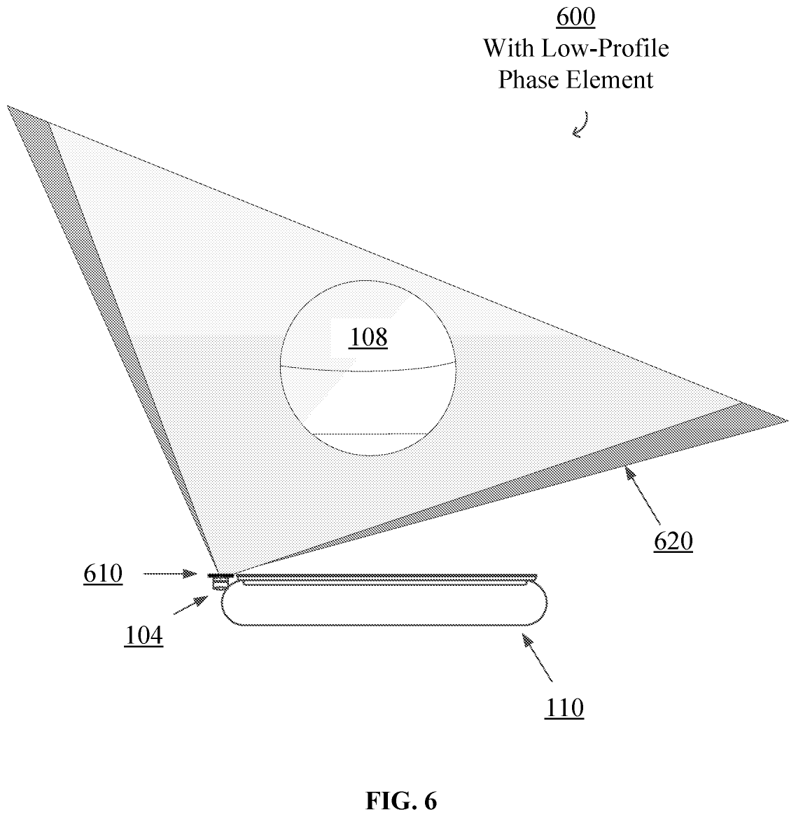

FIG. 6 provides an approach that may address issues illustrated and described herein (e.g., associated with FIGS. 5A-B). FIG. 6 illustrates the FOV 600 of a camera 104 positioned adjacent to the lens system 110 and provides a low-profile phase element 610, which may include a holographic optical element (also referred to herein as HOE). HOEs may be an optical component (mirror, lens, direction diffuser, etc.) that produces holographic images using principles of light diffraction. For simplicity, multipurpose sensor 106 of FIG. 1 is omitted from the description of the low-profile phase element system, but the low-profile phase element system and multipurpose sensor 106 may be used together or separately.

HOEs may include at least one of a Volume Bragg Grating (VBG), a Polarization Volume Hologram (PVH), or a diffractive optical element (DOE), including surface relief gratings (SRGs), binary kinoforms, or the like. Other implementations of low-profile phase elements may include a Pancharatnam-Berry Phase Elements (PBP), meta-surface phase element, or a prism, such as a Fresnel prism or first order Fresnel lens.

The low-profile phase element 610 is positioned in front of the camera 104 and diffracts the camera's FOV 620 to fully capture the eye 108 for eye tracking operations. The low-profile phase element 610 may prevent clipping of the FOV (e.g., camera FOV 620) of camera 104 (as in FIG. 5A) and may not protrude into the lens's FOV (as in FIG. 5B). As such, the low-profile phase element 610 enables the camera 104 to be lowered, e.g., beneath a horizontal plane of the lens 110 (e.g., waveguide 110). In various examples, the lens 110 and the HOE (e.g., low-profile element 610) are flush (e.g., level) on the same horizontal plane. In other examples, the low-profile phase element 610 and the camera 104 are positioned beneath a horizontal plane defined by the surface of the lens 110, and the low-profile phase element 610 prevents clipping, blockage, or obstruction of the FOV of camera 104 (e.g., camera FOV 620).

In examples, the low-profile phase element 610 deflects the FOV of camera 104 into a desired direction. In particular, the low-profile phase element 610 may be a diffraction based optical element that has an ability to bend light rays in a desired fashion. As such, the camera 104 and low-profile phase element 610 may be placed in a variety of positions relative to the lens 110, and still achieve the desired FOV to accurately perform eye tracking operations. Therefore, once the low-profile phase element 610 is attached to a camera 104, the camera's FOV 620 may be diffracted such that it covers the eye 108 and any desired facial regions or facial features, even when the low-profile phase element 610 is at the surface level of the lens 110 and does not protrude into the eye relief zone (e.g., eye relief zone 520).

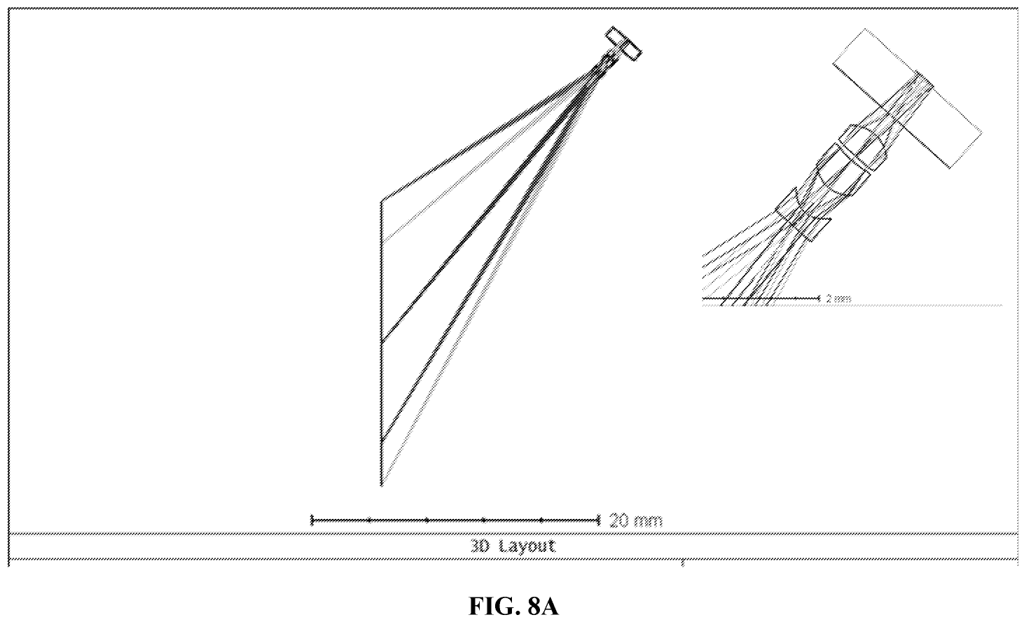

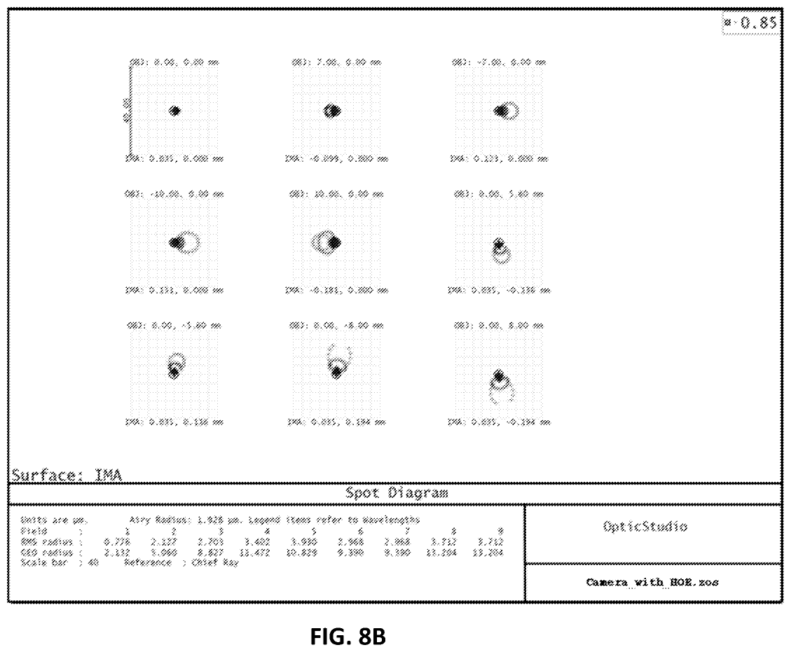

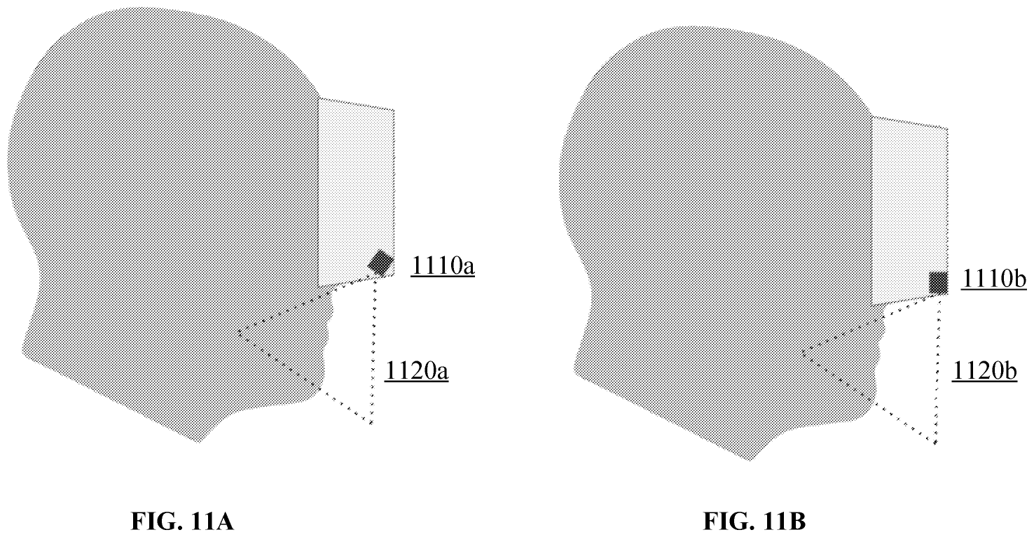

Additional benefits of the examples discussed herein include concealment of cameras around lens architectures in various head-mounted configurations, such as artificial reality and virtual reality devices. The configurations may further save space for lower face tracking cameras, such as those in virtual reality systems, or configurations where there is limited space (see, e.g., FIGS. 11A-B). In many head-mounted systems, such as glasses, gaming devices, and the like, the camera (e.g., camera 104) orientation allowed by the low-profile phase element systems may enable improved placement and packaging (see, e.g., FIGS. 8A-B). The addition of low-profile phase element systems may allow for variable placement of the camera (e.g., camera 104) in an optimal position, while only having to slightly affect the movement of the external lens, if movement of the external lens is necessary. Thus, allowing for a flush (e.g., level) finish or frame 102 of HMD 100 with the lens. The lens may be attached to the camera or attached to another portion of the HMD 100. Low-profile phase element systems may provide an unobstructed view of camera's 106 FOV (e.g., camera's FOV 602) in comparison to obstructed FOV 510 (as shown in FIG.5) of conventional systems.

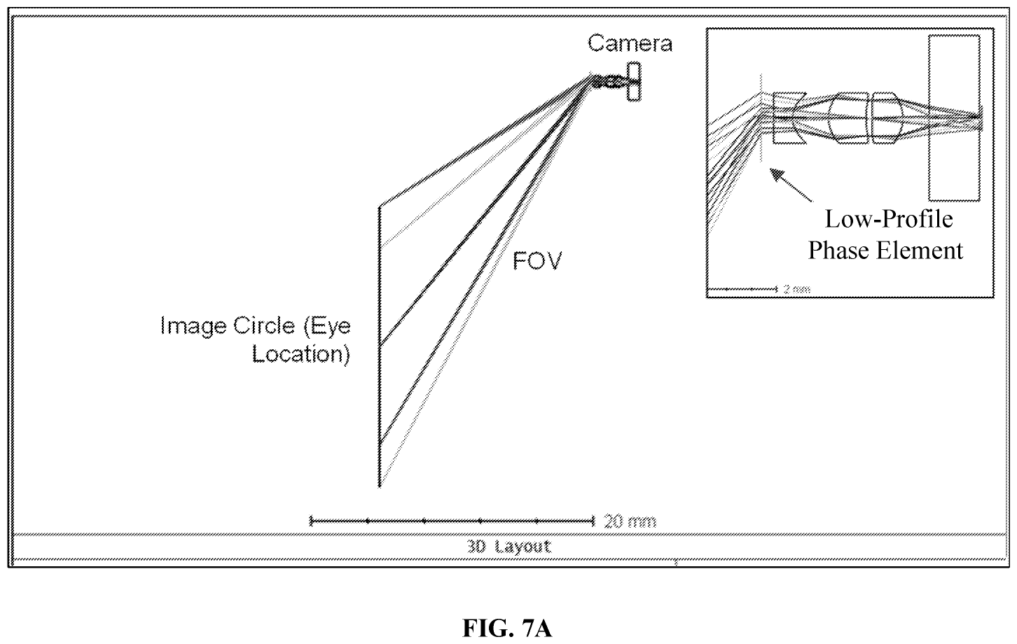

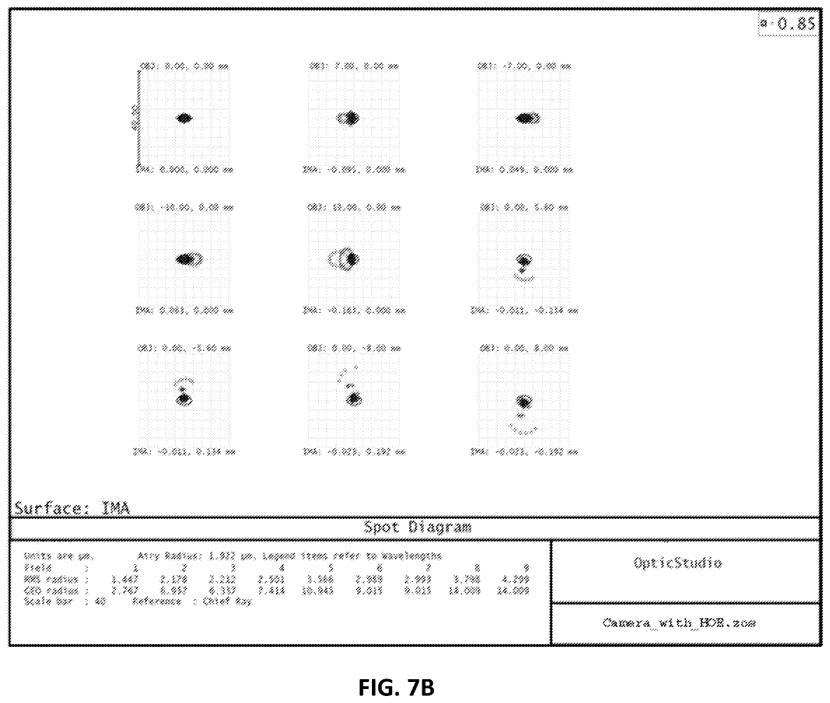

FIG. 7A illustrates a ray tracing analysis for an exemplary system comprising a low-profile phase element (e.g., low-profile phase element 610) positioned in front of a camera (e.g., camera 104), and wherein the low-profile phase element 610 is configured to diffract the camera's FOV (e.g., camera FOV 620). In the illustrated example, a low-profile phase element 610 positioned in front of a camera 160 generated the tracing analysis. FIG. 7A illustrates the diffraction of light rays as they pass through the low-profile phase element 610. FIG. 7B provides the corresponding spot diagram for the same configuration.

FIG. 8A illustrates a ray tracing analysis for a linear system for systems that do not utilize a low-profile phase element (such as, low-profile phase element 610). FIG. 8B provides the corresponding spot diagram for the same configuration. A comparison of the tracing analyses, namely FIGS. 7A-7B with FIGS. 8A-8B, illustrate that the low-profile phase element 610 does not introduce noticeable aberrations. For example, for a 20 mm×10 mm FOV, the low-profile phase element system is close to the diffraction limit, and allows for a large acceptance angle range, e.g., greater than 30 degrees for a 20 mm FOV.

### B. Eye Tracking Waveguide Closed Loop Reflection

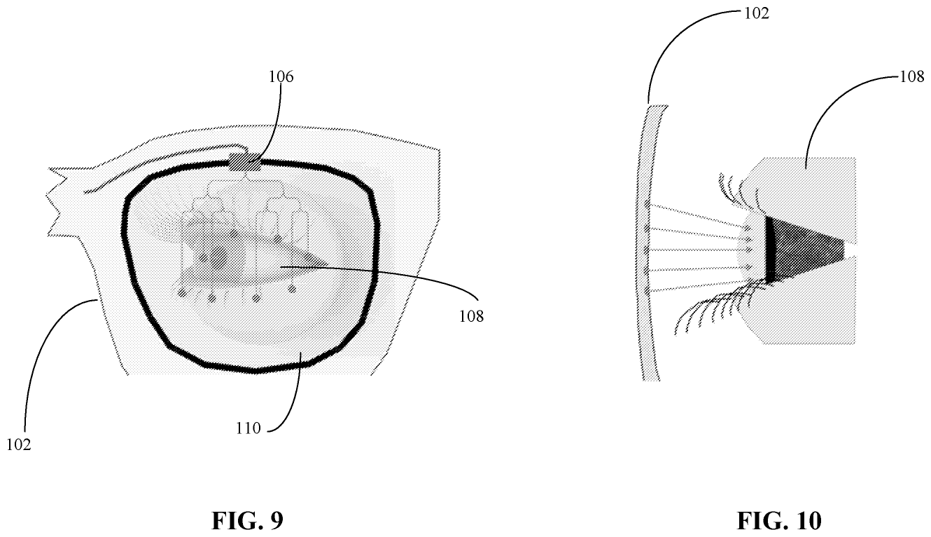

FIG. 9 illustrates an exemplary zoomed plan view of HMD 100 that includes waveguide 110, frame 102, and multipurpose sensor 106 in the dashed circle A of FIG. 1. For simplicity multipurpose sensor 106 and configuration of low-profile phase element 610 placed in front of camera 104 are described separately, but they may be utilized together or separately. The conventional HDM 100 design requires a camera to respond to the reflection off the eyes, but using multipurpose sensor 106, as disclosed, there may be a reduction in space, cost, or weight for HMD 100, as well as potentially reducing interference with the display path that may disrupt the users experience. Multipurpose sensor 106 may be located on frame 102 in different positions. Multipurpose sensor 106 may take the entire the width of a section of frame 102, may be just on one side of frame 102 (e.g., nearest to the user's eye), or may be located on waveguide 110.

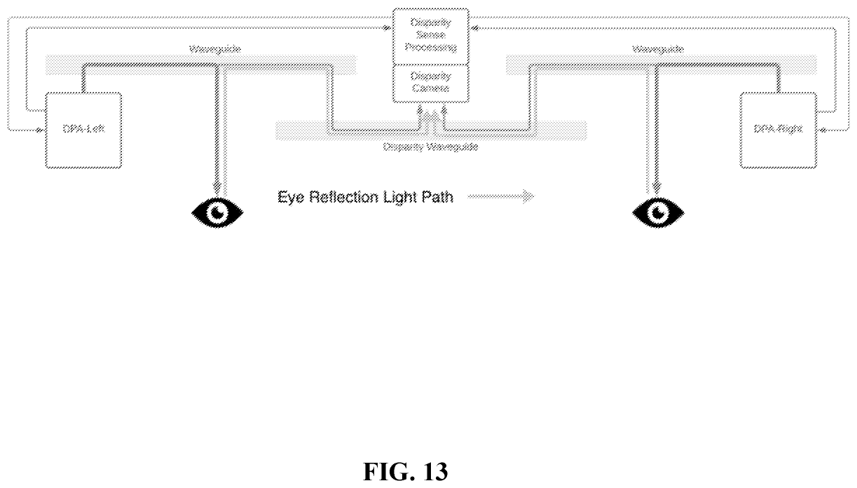

FIG. 10 illustrates an exemplary zoomed side view of FIG. 9. Multipurpose sensor 106 may obtain information from eye 108 or waveguide 110 (e.g., lens 110) in a way that substitutes the need of information from conventional waveguides 108, cameras, or other sensors. In an example, multipurpose sensor 106 may detect changes in visible light, infrared light, or other light frequencies, or changes in the path of the light (e.g., FIG. 13) that may be detected on waveguide 110 or near waveguide 110. The obtained information may be translated into output associated with angular space, which may be utilized for eye tracking.

FIGS. 11A-11B illustrate examples for a lower face tracking camera. FIG. 11A illustrates an example without a tracking apparatus 1110a comprising a low-profile phase element 610 placement in front of a camera (e.g., camera 104) or multiple purpose sensor 106 that make up an eye tracking system. FIG. 11B illustrates an example of a tracking apparatus 1110b utilized for eye tracking comprising a low-profile phase element 610 placed in front of camera 104 and multipurpose sensor 106. FOVs 1120a, 1120b are similar, capturing a similar region of the lower face. However, the inclusion of a low-profile phase element 610 or multipurpose sensor in the configuration of FIG. 11B allows for a more efficient, space-saving placement of tracking aparatus1110b. As discussed herein, camera configurations without a low-profile phase element 610 may require the camera to be linearly directed toward the area of observation, and in some cases, the cameras FOV or the FOVs of associated systems, such as a lens system, may be obstructed. The implementation of a low-profile phase element 610 or a multipurpose sensor 106 allows for customizable FOVs and may enable significantly more placement options of cameras and optical elements, especially in configurations where there is limited space.

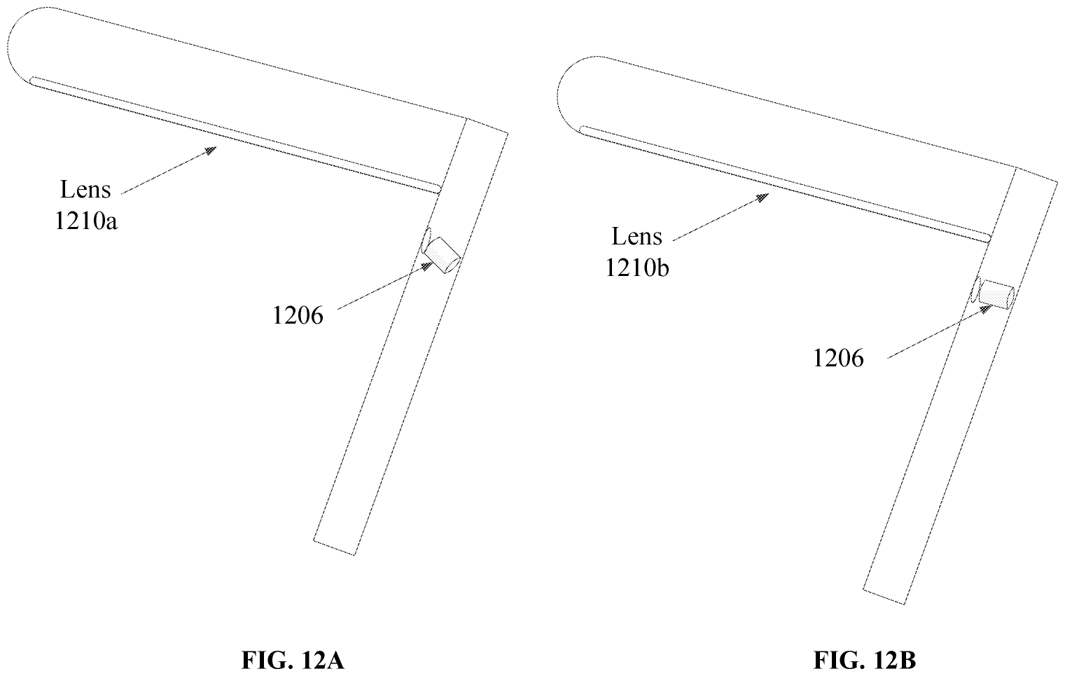

FIGS. 12A-12B illustrate examples for camera (e.g., camera 104) placement in a head-mounted device comprising glasses. In various examples, head-mounted systems (such as HMD 100) may include glasses or sunglasses having a lens 1210a, 1210b, and with camera 1206 mounting within the frame (e.g., frame 102) of the glasses. The illustrated systems are another example of a system with limited space for camera components. FIG. 12A illustrates a traditional camera 1206 configuration and positioning. The camera 1206 is angled relative to the frame to linearly capture the desired FOV (e.g., camera FOV 620). FIG. 12B illustrates a more efficient placement of camera 1206, and uses a low-profile phase element 610, which enables an unobstructed FOV of camera 104 to be captured. Again, the addition of the low-profile phase element 610 enables more efficient packaging and more options than traditional configurations. FIG. 13 illustrates an exemplary pathway of light reflected from an eye, utilizing tracking apparatus 1110b of FIG. 11B of FIG. 12B.

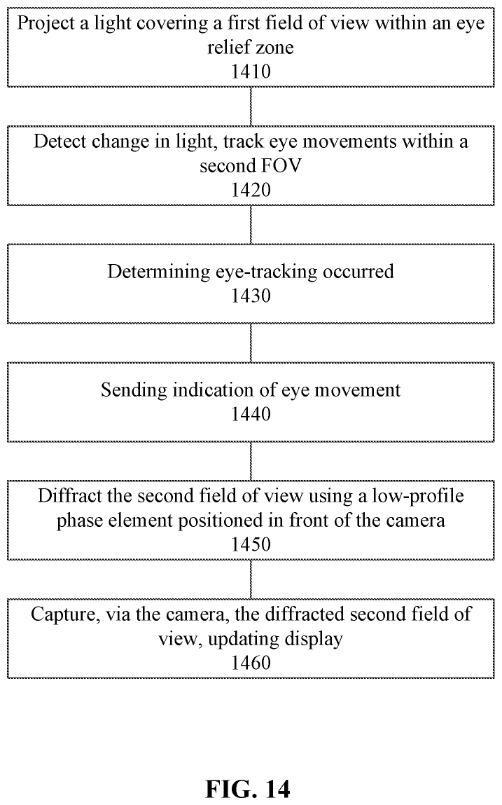

FIG. 14 provides a flowchart of a method of eye tracking associated with a camera low-profile phase element 610 and a multipurpose sensor 106, in accordance with an example of the present disclosure. In examples, an image (or light) covering a first FOV may be projected or directed, for example, by a lens (e.g., waveguide), within an eye relief zone (e.g., eye relief zone 120) to a user's eye (e.g., eye 108), at step 1410.

At step 1420, detecting via multipurpose sensor 106, a change in light frequency or path of light (e.g., shadows). Light reflected from the user's eyes (e.g., eye 108) is transmitted via the lens (e.g., waveguides) to multipurpose sensor 106 (e.g., disparity camera or other sensor) which responds to eye reflection data. Further at step 1420, camera (e.g., camera 104) may track eye movements within a second FOV, as defined by the camera. In an example, the camera is positioned adjacent to the lens module. A processor in HMD 100 uses this information obtained, via the multipurpose sensor 106 or camera 104, to calculate user eye disparity data.

At step 1430, comparing the change in light frequency or path of light of step 1420 to a threshold to determine, based on the comparison, that eye tracking has occurred. At step 1440, sending an indication of eye movement (e.g., position or an alert) that an eye-tracking action occurred (e.g., eye tracked to indicate it moved southwest by a certain amount). At step 1450, based on the indication of eye movement, a low-profile phase element placed in front of the camera may diffract the second FOV. In various examples, the second FOV may be diffracted toward a region of interest, such as an eye, a light observing element, a face, or other area. In examples, the camera 104 captures the diffracted second FOV, which captures a greater portion of the first FOV. At step 1460, based on the diffraction of the second FOV, what is displayed on the waveguide 110 (e.g., lens) is updated. The system may communicate user eye disparity data to a light projector coupled with waveguide 110 (e.g., display projector assembly) to form a closed loop.

The method may be iterative and continually compare light changes and diffract the second FOV associated with movement of the eye (e.g., eye 108).

### C. Interchangeable Eye Tracking Calibration

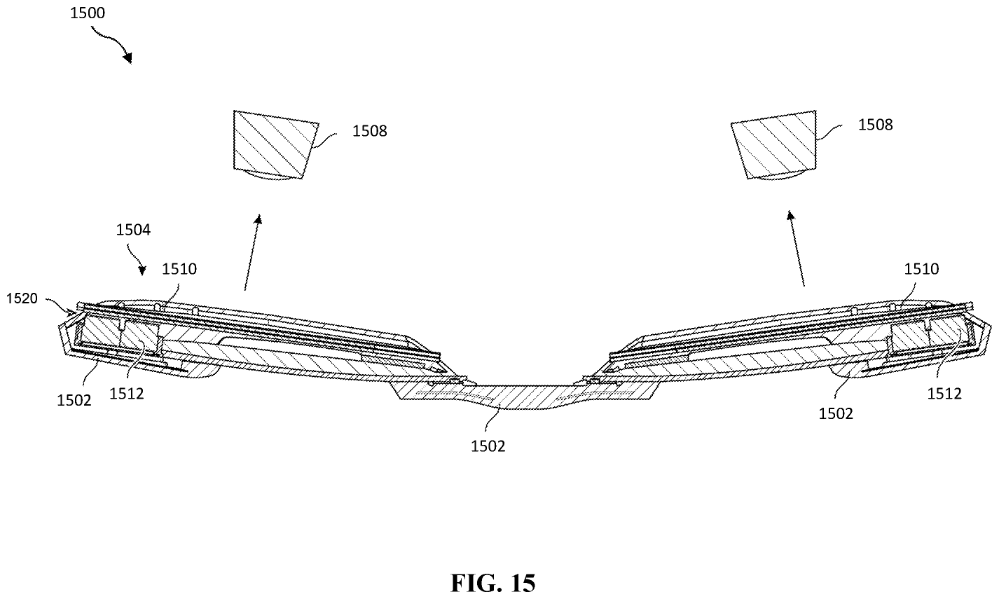

FIG. 15 is a cross-sectional view of a HMD 1500 (e.g., HMD 100). In an exemplary embodiment HMD 1500 may include artificial eyes 1508 used for testing in accordance with an example. Artificial eyes 1508 may also be alignment cameras. In at least some respects, the HMD 1500 may be similar to the HMD 100 described in FIG.1. For example, the HIVID 1500 may include a frame 1502, and a display assembly 1504 (e.g., lens module 110) including a light projector 1512 and a waveguide 1510 mounted to the frame 1502.

The artificial eyes 1508 may be used during assembly of the HMD 1500 to aid in the calibration of eye tracking systems in coordination with eye tracking camera (e.g., camera 104). For example, the artificial eyes 1508 may be used to detect the gaze vector, pupil location, eye features, etc., via eye tracking system. This detected information may be used to adjust position or orientation of eye tracking camera (e.g., camera 104) relative to the frame 1502. In additional examples, the artificial eyes 1508 may represent an alignment camera during development of HMD 1500, where the alignment camera may be used to optically align the light projector 1512 with the frame 1502 or to optically align the waveguide 1510 with the light projector 1512 for eye tracking purposes. For example, the alignment cameras 1508 may be used to detect the location or orientation of a fiducial mark, a physical component or feature, a reflective material, etc. This detected information may be used to adjust a position or orientation of the light projector 1512 relative to the frame 1502 or of the waveguide 1510 relative to the light projector 1512 or frame 1502.

As shown in FIG. 15, a gap 1520 may exist between the waveguide 1510 and the light projector 1512. Thus, in some embodiments, the waveguide 1510 and the light projector 1512 may not be directly coupled to each other. Rather, the light projector 1512 and the waveguide 1510 may each be separately mounted to the frame 1502. This may allow for adjustments in relative position or orientation between the light projector 1512 and the waveguide 1510.

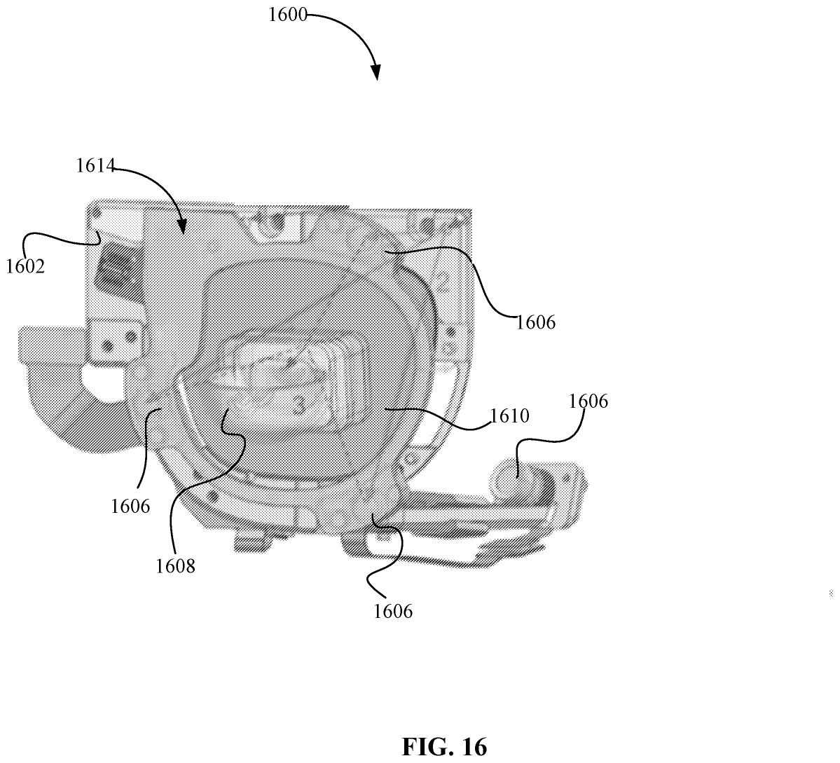

FIG. 16 illustrates a calibration system 1600 positioned anteriorly to an eye tracking system 1600 in accordance with an example. Artificial eye 1608 may be an alignment camera. Eye tracking system 1614 may comprise a tracking camera(s) 1606 (e.g., camera 104). The eye tracking system 1614 may be positioned posteriorly to the calibration system 1600, where the eye tracking system 1614 may capture movements of the artificial eye 1608 and reflections of light from the artificial eye 1608 as light passes through a lens 1610 of the calibration system 1600.

As shown in FIG. 16, the calibration system 1600 may include a mount 1602, a calibration camera 1606, and a lens 1610. Calibration camera 1606 may possess calibrated ground truth data and kinematic mounting features. A kinematic mount may restrict the degrees of freedom of an eye tracking module that is attached to the system (i.e., calibration system 1600) for evaluation. The kinematic mounting feature may restrict the calibration camera 1606 to six degrees of freedom to ensure a rigid connection, thus creating a system that is repeatable. Due to the kinematic mounting features, calibration system 1600 may be placed into the same position on a different eye tracking system within micron positional error. For example, the calibration camera 1606 may be mounted rigidly in a way that allows for the capture of certain degrees of freedom, i.e., camera may capture artificial eye 1608 movement if movement is in direction that corresponds with yawing (twist or oscillate about a vertical axis), forward/backward (surge), up/down (heave), left/right (sway) translation, pitch (transverse axis), roll (longitudinal axis), or any eye movement in any direction within a particular volume in space. Calibration camera 1606 may be positioned anteriorly away from the artificial eye 1608 at any distance that allows for capture of key performance indicators (KPI) of the artificial eye 1608 movements in coordination with the eye tracking system 1614. Mount 1602 may be magnetized to allow for ease of attachment and detachment of calibration system 1600 to eye tracking system 1614 and vice versa.

The artificial eyes 1608 may be used during assembly of the HMD 300 to aid in the calibration of eye tracking systems 1614 in coordination with eye tracking camera 1604 (e.g., camera 104). The eye tracking system 1614 may assess the movements of artificial eye 1608 as light is directed through lens 1610. The calibration camera 1606 (e.g., calibrated ground truth camera) may assess movements of the artificial eye 1608, via reflections of light from artificial eye 1608, in coordination with eye tracking system 1614 movements to determine KPIs such as gaze vector, interpupillary distance, or any important information necessary for eye tracking as light passes through lens 108 and reflected from artificial eye 1608. This data may then be compared to ground truth data to determine the performance of the eye tracking system 1614. For example, after a series of tests the calibration camera 1606 may capture KPI (e.g., gaze vector, pupil location, etc.) of eye tracking system 1614 for an artificial eye 1608 as light passes through lens 1610 (e.g., waveguide 110 or lens 110). The data collected while assessing the KPI of the eye tracking system 1614 with artificial eye 1608 may be compared to the ground truth data calibrated within the calibration system to determine if the KPI of the eye tracking system is sufficient.

In conventional systems, every KPI may need to be assessed using a different calibration system 1600 or method as the artificial eye moves, which may require continual recalibration of the calibration system 1600 and eye tracking system 1614 as each component of KPI is assessed. In the embodiment disclosed, the calibration system 1600 may be calibrated before testing and due to the rigidness of the system as well as the kinematic mounting features the ground truth data of the calibration system 1600 may stay constant to what it was originally calibrated to. Due to mount 1602 being magnetized allowing for ease of attachment and detachment of calibration system 1600 from eye tracking system 1614, the calibration system 1600 may be moved from one arbitrary eye tracking system to another. Calibration system 1600 (i.e., ground-truth system) may be calibrated, enabling removable eye tracking systems (e.g., eye tracking system 1604), with varying designs, to be assessed and determine KPI. KPI may be benchmarked by the ground truth system for future use on similar eye tracking systems.

The foregoing description of the embodiments has been presented for the purpose of illustration; it is not intended to be exhaustive or to limit the patent rights to the precise forms disclosed. Persons skilled in the relevant art may appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which may be executed by a computer processor for performing any or all of the steps, operations, or processes described.

Embodiments also may relate to an apparatus for performing the operations herein. This apparatus may be specially constructed for the required purposes, or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

The language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

What is claimed:

1. A system, comprising:
a lens module configured to project an image covering a first field of view within an eye relief zone;
a camera positioned adjacent to the lens module and configured to track eye movements within a second field of view defined by the camera, wherein the camera does not protrude into the eye relief zone; and
a low-profile phase element positioned in front of the camera and configured to diffract the second field of view of the camera to capture a greater area of the first field of view, wherein the low-profile phase element does not protrude into an eye relief zone.

2. The system of claim 1, wherein the eye relief zone is based on a distance between a light observing element and the lens module.

3. The system of claim 1, wherein the first field of view is an observable field of view for a light observing element positioned a distance from the lens module.

4. The system of claim 1, wherein the low-profile phase element is a holographic optical element (HOE).

5. They system of claim 4, wherein the HOE includes at least one of a Volume Bragg Grating (VBG), a Polarization Volume Hologram (PVH), or a diffractive optical element (DOE), including surface relief gratings (SRGs), binary kinoforms, or any diffractive optical element.

6. The system of claim 1, wherein the low-profile phase element is a Pancharatnam-Berry Phase Element (PBP), meta-surface phase element, or a prism, such as a Fresnel prism or first order Fresnel lens.

7. The system of claim 1, further comprises a multipurpose sensor that detects changes in light to track a user's eye.

8. A method, comprising:
detecting, by a multipurpose sensor, a change in light frequency or path of light; comparing the change to a threshold;
determining, based on the comparison, that an eye-tracking action occurred;
sending an indication that an eye-tracking action occurred; and
based on the indication, updating what is displayed on a waveguide.

9. A system comprising:
a waveguide having a front and a rear surface, the waveguide for a display system and arranged to guide light onto an eye of a user to make an image visible to the user, the light guided through the waveguide; and
a multipurpose sensor that detects changes in light to track a user's eye.

10. The system of claim 9, wherein the system comprises a head mounted display system.

11. The system of claim 9, further comprising:
a test object;
an eye tracking system; and
a camera, wherein the camera comprises calibrated ground truth data, wherein the system is configured to:
capture reflections of light and movement of the test object; and
determine performance of multiple eye tracking systems.
